(19) United States
(12) Patent Application Publication
(10) Pub. No.: US 2026/0321973 A1
(43) Pub. Date: Oct. 15, 2026

(54) DIRECTOR STRUCTURE, BASE STATION ANTENNA, AND BASE STATION

(71) Applicant: Huawei Technologies Co., Ltd., Shenzhen (CN)

(72) Inventors: Zijing Du, Xi'an (CN); Jun Shu, Dongguan (CN); Dingjiu Daojian, Dongguan (CN); Yingjie Zhang, Shenzhen (CN); Chengdai Xue, Dongguan (CN)

(21) Appl. No.: 19/465,490

(22) Filed: Jan. 30, 2026

Related U.S. Application Data
(63) Continuation of application No. PCT/CN2024/099046, filed on Jun. 13, 2024.

(30) Foreign Application Priority Data
Aug. 2, 2023 (CN) 202310970738.X

(51) Int. Cl. H01Q 1/52; H01Q 1/24; H01Q 9/16

(52) U.S. Cl. CPC H01Q 1/523; H01Q 1/246; H01Q 9/16

(57) ABSTRACT

A director structure, a base station antenna, and a base station are provided. The director structure includes a first director and at least one second director. The first director has a through hole, the at least one second director is disposed inside the through hole, and a first end of the at least one second director is fastened to the first director. At least one first stub is disposed on an outer edge of the first director, the at least one first stub extends along an outer edge contour of the first director, and the at least one first stub is fastened to the first director. The first end of the second director has an opening, the opening extends in an extension direction of the second director, a second stub is disposed in the opening, and the second stub extends in the extension direction of the second director.

### CROSS-REFERENCE TO RELATED APPLICATIONS

This application is a continuation of International Application No. PCT/CN2024/099046, filed on Jun. 13, 2024, which claims priority to Chinese Patent Application No. 202310970738.X, filed on Aug. 2, 2023. The disclosures of the aforementioned applications are hereby incorporated by reference in their entireties.

### TECHNICAL FIELD

This application relates to the antenna field, and in particular, to a director structure, a base station antenna, and a base station.

### BACKGROUND

With rapid development of wireless communication technologies, capacity requirements on communication systems are increasingly large, and broadband antennas and multi-band antennas are widely used in base station antennas. Loading a director for a low-frequency antenna can broaden bandwidth of the low-frequency antenna, and implement antenna broadband. However, in multi-band antenna systems, introduction of a director causes strong interference to radiation performance of high-frequency antennas in multi-band antennas.

### SUMMARY

This application provides a director structure, a base station antenna, and a base station, to reduce interference of a director to radiation performance of a high-frequency antenna.

According to a first aspect, this application provides a director structure, which may be disposed above an antenna structure. The director structure may include a first director and at least one second director. The first director may have a through hole, the at least one second director may be disposed inside the through hole, and a first end of the at least one second director may be fastened to the first director. At least one first stub may be disposed on an outer edge of the first director, the at least one first stub may extend along an outer edge contour of the first director, and the at least one first stub may be fastened to the first director. The first end of the second director may have an opening, the opening may extend in an extension direction of the second director, a second stub may be disposed in the opening, and the second stub may extend in the extension direction of the second director.

In the technical solution provided in this application, a high-frequency antenna in a multi-band antenna may generate an induced current I1 on the first stub, a direction of the induced current I1 is opposite to a direction of an induced current I2 generated by the high-frequency antenna on the first director, and the induced current I1 and the induced current I2 can cancel each other, which is equivalent to a case in which no induced current is generated on the first director. Therefore, the first stub may be disposed to implement wave transmission of the first director. The high-frequency antenna in the multi-band antenna may generate an induced current J1 on the second stub, a direction of the induced current J1 is opposite to a direction of an induced current J2 generated by the high-frequency antenna on the second director, and the induced current J1 and the induced current J2 can cancel each other, which is equivalent to a case in which no induced current is generated on the second director. Therefore, the second stub may be disposed to implement wave transmission of the second director. In this way, the director structure has a wave transmission characteristic, and can both broaden bandwidth of the low-frequency antenna in the multi-band antenna, and implement wave transmission for the high-frequency antenna in the multi-band antenna, resulting in minimal interference to radiation performance of the high-frequency antenna. In addition, the director structure is disposed above the antenna structure. For example, the director structure is disposed above a low-frequency antenna in the multi-band antenna. There is no direct electrical connection between the director structure and the low-frequency antenna. Disposing of the first stub and the second stub has small impact on impedance matching between the director structure and the low-frequency antenna, and has small impact on radiation performance of the low-frequency antenna.

In a specific implementation solution, the director structure may include four second directors, the four second directors may be arranged axially around the through hole, two second directors may be arranged in a first direction, the other two second directors may be arranged in a second direction, and the first direction may be perpendicular to the second direction. The four second directors may respectively correspond to four elements of a dipole low-frequency antenna. This expands the bandwidth of the low-frequency antenna.

When the second stub is specifically disposed, the second stub may include a first segment, a second segment, and a third segment, the first segment may extend in the extension direction of the second director, the second segment and the first segment may be disposed in parallel, and the first segment may be fastened to the second segment via the third segment. The third segment may be fastened to the second director, to implement a connection between the second stub and the second director.

In a specific implementation solution, one end of the third segment may be fastened to one end of the first segment, the other end of the third segment may be fastened to one end of the second segment, and the first segment and the second segment may be located on a same side of the third segment. The third segment, the first segment, and the second segment may integrally form the second stub of a U-shaped structure, and the second director having an opening may also be considered as a U-shaped structure. The induced current generated by the high-frequency antenna on the second stub and the induced current generated by the high-frequency antenna on the second director have similar paths and opposite directions, and can cancel each other with each other, to implement wave transmission of the second director.

In an optional solution, the first director may be circular. In another optional solution, the first director may be square.

In a specific implementation solution, the first stub may be fastened to the first director via a first connecting member, to implement fastening between the first stub and the first director.

In a specific implementation solution, one end of the first connecting member may be fastened to one end of the first stub, and the other end of the first connecting member may be fastened to the first director. In this way, the induced current generated by the high-frequency antenna on the first stub and the induced current generated by the high-frequency antenna on the first director have similar paths and opposite directions, and can cancel each other with each other, to implement wave transmission of the first director.

In a specific implementation solution, the third segment may be fastened to the second director via a second connecting member, to implement fastening between the second stub and the second director.

In a specific implementation solution, the second connecting member, the first segment, and the second segment may be located on a same side of the third segment, so that layout space within a range of the opening of the second director can be effectively used.

According to a second aspect, this application provides a base station antenna. The base station antenna may include an antenna structure and the director structure according to any one of the implementation solutions of the first aspect. The director structure is disposed above the antenna structure. The director structure can both broaden bandwidth of a low-frequency antenna in a multi-band antenna, and implement wave transmission for a high-frequency antenna in the multi-band antenna, resulting in minimal interference to radiation performance of the high-frequency antenna, and achieving ideal performance of the base station antenna.

According to a third aspect, this application provides a base station. The base station may include the base station antenna according to the second aspect. The base station has reliable performance and high stability.

### BRIEF DESCRIPTION OF THE DRAWINGS

FIG. 1 is a diagram of a system architecture to which an embodiment of this application is applicable;

FIG. 2 is a diagram of a structure of an antenna feed system of a base station shown in the foregoing figure according to an embodiment;

FIG. 3 is a diagram of a structure of a base station antenna according to a possible embodiment of this application;

FIG. 4 is a diagram of a possible architecture of a director structure according to an embodiment of this application;

FIG. 5 is a diagram of a structure of a director structure according to a possible embodiment of this application;

FIG. 6 is a diagram of a direction of an induced current of a director structure according to a possible embodiment of this application;

FIG. 7 is a diagram of a structure of a second stub of a director structure according to a possible embodiment of this application;

FIG. 8 is a diagram of a structure of a director structure according to another possible embodiment of this application; and

FIG. 9 is a diagram of a structure of a director structure according to another possible embodiment of this application.

Reference numerals:

| | | | |
|---|---|---|---|
| 10: Antenna; | 20: Pole; | 30: Antenna | 40: Radome; |
| | | adjustment | |
| | | bracket; | |
| 50: Radio | 60: Signal | 70: Cable; | 80: Feed |
| frequency | processing | | network; |
| processing | unit; | | |
| unit; | | | |
| 11: Radiating | 12: Reflection | 81: Transmission | 82: Calibration |
| element; | plate; | component; | network; |
| 83: Phase | 84: Combiner; | 85: Filter; | 100: Director |
| shifter; | | | structure; |
| 200: Low- | 300: High- | 110: First | 120: Second |
| frequency | frequency | director; | director; |
| antenna; | antenna; | | |
| 130: First | 140: Second | 150: First | 160: Second |
| stub; | stub; | connecting | connecting |
| | | member; | member; |
| 111: Through | 121: Opening; | 141: First | 142: Second |
| hole; | | segment; | segment; and |
| 143: Third | | | |
| segment. | | | |

### DETAILED DESCRIPTION OF ILLUSTRATIVE EMBODIMENTS

To make the objectives, technical solutions, and advantages of this application clearer, the following further describes embodiments of this application in detail with reference to the accompanying drawings. However, example implementations can be implemented in a plurality of forms, and should not be construed as being limited to implementations described herein. Identical reference numerals in the figure denote identical or similar structures. Therefore, repeated descriptions thereof are omitted. Words that express positions and directions in embodiments of this application are described by using the accompanying drawings as examples. However, changes may also be made as required, and all the changes fall within the protection scope of this application. The accompanying drawings in embodiments of this application are merely used to illustrate a relative position relationship and do not represent an actual scale.

Specific details are described in the following descriptions to facilitate understanding of this application. However, embodiments of this application can be implemented in a plurality of manners different from those described herein, and a person skilled in the art can perform similar promotion without departing from the connotation of embodiments of this application. Therefore, this application is not limited to specific implementations disclosed below.

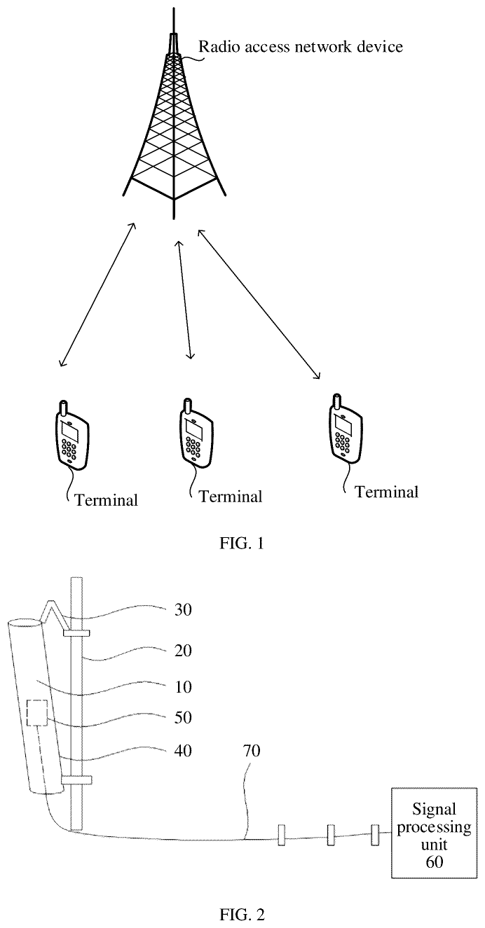

FIG. 1 illustrates a system architecture to which an embodiment of this application is applicable. As shown in FIG. 1, the system architecture may include a radio access network device and a terminal, for example, include but is not limited to a base station shown in FIG. 1. Wireless communication may be implemented between the radio access network device and the terminal. The radio access network device may be in a base station subsystem (BSS), a terrestrial radio access network (UTRAN), or an evolved terrestrial radio access network (E-UTRAN), and is configured to provide cell coverage of a radio signal, to implement connection between a terminal device and a radio frequency end of a wireless network. Specifically, the base station may be a base transceiver station (BTS) in a GSM or CDMA system, or may be a NodeB (NB) in a WCDMA system, or may be an evolved NodeB (eNB or eNodeB) in an LTE system, or may be a radio controller in a cloud radio access network (CRAN) scenario. Alternatively, the base station may be a relay station, an access point, a vehicle-mounted device, a wearable device, a base station in a future 5G network, a base station in a future evolved PLMN network, or the like, for example, a new radio base station. This is not limited in embodiments of this application.

FIG. 2 is a diagram of a structure of an antenna feed system of the base station shown in the foregoing figure according to an embodiment. The antenna feed system of the base station may generally include structures such as an antenna 10, a pole 20, and an antenna adjustment bracket 30. The antenna 10 of the base station includes a radome 40. The radome 40 has a good electromagnetic wave penetration characteristic in terms of electrical performance, and can withstand impact of an external harsh environment in terms of mechanical performance, so that the radome 40 can protect an antenna system from being affected by an external environment. The radome 40 may be mounted on the pole 20 or a tower via the antenna adjustment bracket 30, to facilitate receiving or transmitting a signal by the antenna 10.

In addition, the base station may further include a radio frequency processing unit 50 and a signal processing unit 60. For example, the radio frequency processing unit 50 may be configured to perform frequency selection, amplification, and down-conversion on a signal received by the antenna 10, convert the processed signal into an intermediate frequency signal or a baseband signal, and send the intermediate frequency signal or the baseband signal to the signal processing unit 60; or the radio frequency processing unit 50 is configured to perform up-conversion and amplification on an intermediate frequency signal of the signal processing unit 60, and the antenna 10 converts the processed signal into an electromagnetic wave and sends the electromagnetic wave. The signal processing unit 60 may be connected to a feed structure of the antenna 10 via the radio frequency processing unit 50, and is configured to process an intermediate frequency signal or a baseband signal sent by the radio frequency processing unit 50.

In a possible embodiment, as shown in FIG. 2, the radio frequency processing unit 50 and the antenna 10 may be integrally disposed, and the signal processing unit 60 is located at a remote end of the antenna 10. In some other embodiments, both the radio frequency processing unit 50 and the signal processing unit 60 may alternatively be located at a remote end of the antenna 10. The radio frequency processing unit 50 and the signal processing unit 60 may be connected to each other via a cable 70.

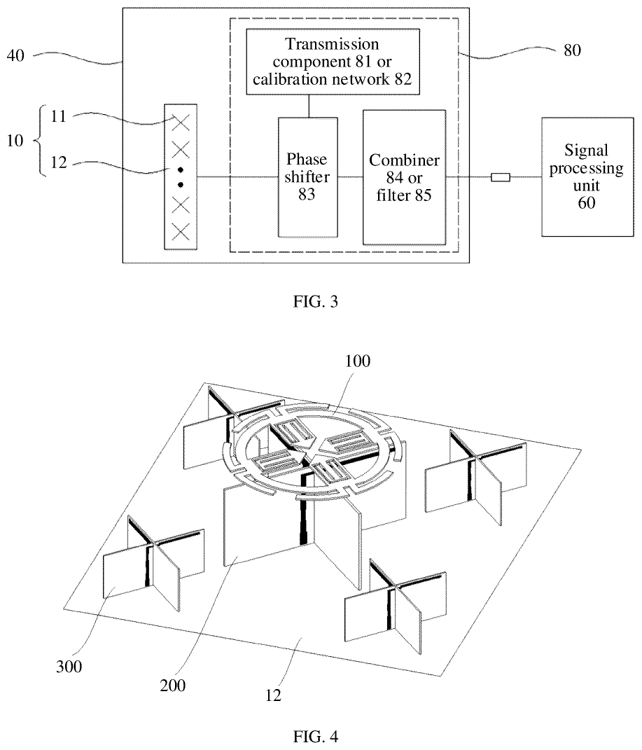

More specifically, refer to FIG. 2 and FIG. 3 together. FIG. 3 is a diagram of a structure of the base station antenna according to a possible embodiment of this application. As shown in FIG. 3, the antenna 10 of the base station may include a radiating element 11 and a reflection plate 12. The radiating element 11 may also be referred to as an antenna element, an element, or the like. The radiating element 11 is a unit that forms a basic structure of an antenna array, and can effectively radiate or receive an antenna signal. In the antenna 10, frequencies of different radiating elements 11 may be the same or different. The reflection plate 12 may also be referred to as a bottom plate, an antenna panel, a metal reflection surface, or the like. The reflection plate 12 may reflect and aggregate an antenna signal at a reception point. The radiating element 11 is usually placed on a surface of a side of the reflection plate 12. This can not only greatly enhance a capability of the antenna 10 to receive or transmit signals, but also block and shield interference caused to antenna signal reception by other electric waves that are from a back of the reflection plate 12 (in this application, the back of the reflection plate 12 is a side opposite to a side that is of the reflection plate 12 and on which the radiating element 11 is disposed).

In the antenna 10 of the base station, the radiating element 11 is connected to a feed network 80. The feed network 80 generally includes controlled impedance transmission lines. The feed network 80 may feed a signal to the radiating element 11 based on a specific amplitude and phase, or send a received signal to the signal processing unit 60 of the base station based on a specific amplitude and phase. In addition, the feed network 80 may implement different radiation beam directions through a transmission component 81, or may be connected to a calibration network 82 to obtain a calibration signal required by the system. The feed network 80 may include a phase shifter 83, configured to change a maximum radiation direction of an antenna signal. A combiner 84 (which may be configured to: combine signals of different frequencies into one signal and transmit the signal using the antenna 10; or may be configured to: during reverse operation, divide signals received by the antenna 10 into a plurality of signals based on different frequencies and transmit the signals to the signal processing unit 60 for processing), a filter 85 (configured to filter out interference signals), and other modules for performance extension may be disposed in the feed network 80.

A director structure provided in embodiments of this application may adapt to the antenna 10 of the base station antenna. A multi-band antenna is widely used in the base station antenna. The multi-band antenna usually includes a low-frequency antenna and a high-frequency antenna. Loading a director for the low-frequency antenna in the multi-band antenna can broaden bandwidth of the low-frequency antenna, and implement antenna broadband. However, introduction of the director causes strong interference to radiation performance of the high-frequency antenna in the multi-band antenna.

In view of this, embodiments of this application provide a director structure, to reduce interference of a director to radiation performance of a high-frequency antenna, and ensure the radiation performance of the high-frequency antenna. The following describes in detail the director structure.

FIG. 4 is a diagram of a possible architecture of a director structure according to an embodiment of this application. As shown in FIG. 4, the director structure 100 may be disposed above an antenna structure. For example, the director structure 100 may be disposed above a low-frequency antenna 200 in a multi-band antenna. Herein, “above” is based on an orientation in FIG. 4, and “above the low-frequency antenna 200” may correspond to one end that is of the low-frequency antenna 200 and that is away from the reflection plate 12. The director structure 100 may be fastened above the low-frequency antenna 200 via a fastener like an insulated bracket. There is no direct electrical connection between the director structure 100 and the low-frequency antenna 200, and there is no direct electrical connection between the director structure 100 and a high-frequency antenna 300.

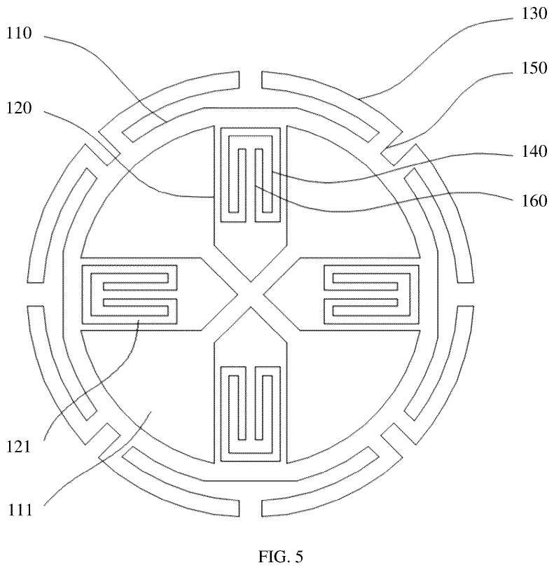

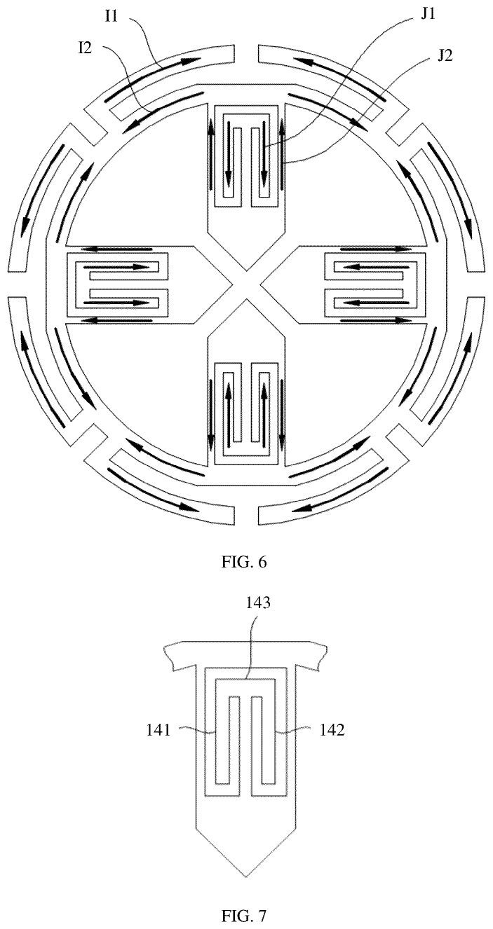

FIG. 5 is a diagram of a structure of the director structure according to a possible embodiment of this application. As shown in FIG. 5, the director structure may include a first director 110 and at least one second director 120. The first director 110 may have a through hole 111. The at least one second director 120 may be disposed inside the through hole 111 of the first director 110. Specifically, a first end of the at least one second director 120 may be fastened to the first director 110, and a second end of the at least one second director 120 may be free.

In a specific implementation, at least one first stub 130 may be disposed on an outer edge of the first director 110, the at least one first stub 130 may extend along an outer edge contour of the first director 110, and the at least one first stub 130 may be fastened to the first director 110. The first end of the second director 120 may have an opening 121, the opening 121 may extend in an extension direction of the second director 120, a second stub 140 may be disposed in the opening 121, and the second stub 140 may extend in the extension direction of the second director 120.

FIG. 6 is a diagram of a direction of an induced current of the director structure according to a possible embodiment of this application. With reference to FIG. 5 and FIG. 6, based on the director structure provided in embodiments of this application, the high-frequency antenna in the multi-band antenna may generate an induced current I1 on the first stub 130, a direction of the induced current I1 is opposite to a direction of an induced current I2 generated by the high-frequency antenna on the first director 110, and the induced current I1 and the induced current I2 can cancel each other, which is equivalent to a case in which no induced current is generated on the first director 110. Therefore, the first stub 130 may be disposed to implement wave transmission of the first director 110. The high-frequency antenna in the multi-band antenna may generate an induced current J1 on the second stub 140, a direction of the induced current J1 is opposite to a direction of an induced current J2 generated by the high-frequency antenna on the second director 120, and the induced current J1 and the induced current J2 can cancel each other, which is equivalent to a case in which no induced current is generated on the second director 120. Therefore, the second stub 140 may be disposed to implement wave transmission of the second director 120. In this way, the director structure has a wave transmission characteristic, and can broaden bandwidth of the low-frequency antenna in the multi-band antenna, and implement wave transmission for the high-frequency antenna in the multi-band antenna, resulting minimal interference to radiation performance of the high-frequency antenna. In addition, there is no direct electrical connection between the director structure and the low-frequency antenna. Disposing of the first stub 130 and the second stub 140 has small impact on impedance matching between the director structure and the low-frequency antenna, and has small impact on radiation performance of the low-frequency antenna.

In a possible implementation, the director structure may include four second directors 120. Specifically, the four second directors 120 may be axially arranged around the through hole 111. Two of the four second directors 120 may be disposed in a first direction, and the other two second directors 120 may be disposed in a second direction. The first direction may be perpendicular to the second direction. During actual mounting of the director structure, the four second directors 120 may respectively correspond to four elements (also referred to as radiation arms) of a dipole low-frequency antenna. This can expand the bandwidth of the low-frequency antenna. In a specific implementation, one end of each second director 120 may be fastened to the first director 110, and the other end of each second director 120 may be free. The other end of the second director 120 may be triangular, the other ends of the four second directors 120 may converge with each other, and a cross-shaped gap may be formed between the other ends of the four second directors 120.

In a possible specific implementation, the first stub 130 may be fastened to an area that is on the first director 110 and that is between two corresponding adjacent second directors 120, and the area may be fastened to two first stubs 130. As shown in FIG. 1, when the director structure includes four second directors 120, an outer edge of the first director 110 may be fastened to eight first stubs 130 in a circumferential direction.

Specifically, when the first stub 130 is connected, the first stub 130 may be fastened to the first director 110 via a first connecting member 150. Specifically, one end of the first connecting member 150 may be fastened to one end of the first stub 130, and the other end of the first connecting member 150 may be fastened to the first director 110, to implement fastening between the first stub 130 and the first director 110. The first stub 130 may be welded to the first connecting member 150 to implement fastening, and the first connecting member 150 may also be welded to the first director 110 to implement fastening. Alternatively, the first stub 130, the first connecting member 150, and the first director 110 may be integrally formed. Alternatively, the first stub 130 and the first connecting member 150 may be integrally formed, and the first connecting member 150 may be welded to the first director 110. Alternatively, the first connecting member 150 and the first director 110 may be integrally formed, and the first stub 130 may be welded to the first connecting member 150.

FIG. 7 is a diagram of a structure of the second stub of the director structure according to a possible embodiment of this application. With reference to FIG. 5 and FIG. 7, in a possible specific implementation, the second stub 140 may include a first segment 141, a second segment 142, and a third segment 143, the first segment 141 may extend in an extension direction of the second director 120, the second segment 142 and the first segment 141 may be disposed in parallel, and the first segment 141 may be fastened to the second segment 142 via the third segment 143. In a specific implementation, one end of the third segment 143 may be fastened to one end of the first segment 141, the other end of the third segment 143 may be fastened to one end of the second segment 142, the first segment 141 and the second segment 142 may be located on a same side of the third segment 143, and the third segment 143, the first segment 141, and the second segment 142 may integrally form the second stub 140 of a U-shaped structure. A first end of the second director 120 has an opening 121, and the second director 120 may also be considered as a U-shaped structure. The induced current generated by the high-frequency antenna on the second stub 140 and the induced current generated by the high-frequency antenna on the second director 120 have similar paths and opposite directions, and can cancel each other with each other, to implement wave transmission of the second director 120. Specifically, when the second stub 140 is connected, the third segment 143 may be fastened to the second director 120, to implement fastening between the second stub 140 and the second director 120.

During actual disposing, the third segment 143 may be fastened to the second director 120 via the second connecting member 160. Specifically, one end of the second connecting member 160 may be fastened to the third segment 143, and the other end of the second connecting member 160 may be fastened to the second director 120, to implement fastening between the third segment 143 and the second director 120, so as to implement fastening between the second stub 140 and the second director 120. The third segment 143 may be welded to the second connecting member 160 to implement fastening, and the second connecting member 160 may also be welded to the second director 120 to implement fastening. Alternatively, the third segment 143, the second connecting member 160, and the second director 120 may be integrally formed. Alternatively, the third segment 143 and the second connecting member 160 may be integrally formed, and the second connecting member 160 may be welded to the second director 120. Alternatively, the second connecting member 160 and the second director 120 may be integrally formed, and the third segment 143 may be welded to the second connecting member 160. The second connecting member 160, the first segment 141, and the second segment 142 may be located on a same side of the third segment 143, so that layout space within a range of the opening 121 of the second director 120 can be effectively used.

In a possible specific implementation, the first director 110 may be circular. The through hole 111 may be a circular hole. In this case, the first director 110 is specifically a circular ring, and the first direction and the second direction may be respectively radial directions of the through hole 111. That is, the first direction may be the radial direction of the through hole 111, the second direction may also be the radial direction of the through hole 111, and the first direction is perpendicular to the second direction. In a specific implementation, an overall outer edge contour of the first director 110 is circular, a partial outer edge contour of the first director 110 is arc-shaped, and the first stub 130 extends along the outer edge contour of the first director 110. Therefore, the first stub 130 may be of an arc-shaped structure. In this way, the induced current generated by the high-frequency antenna on the first stub 130 and the induced current generated by the high-frequency antenna on the first director 110 have similar paths and opposite directions, and can cancel each other with each other, to implement wave transmission of the first director 110.

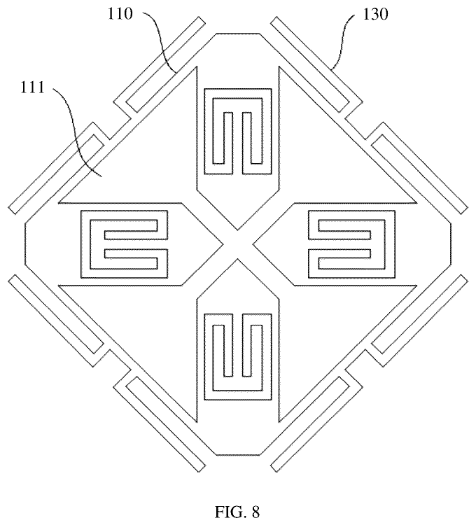

FIG. 8 is a diagram of a structure of the director structure according to another possible embodiment of this application. As shown in FIG. 8, the first director 110 may be square. The through hole 111 may be a square hole. In this case, the first director 110 is specifically a square ring, the first direction and the second direction may be respectively directions of diagonals of the through hole 111, and the first direction is perpendicular to the second direction. In a specific implementation, the first stub 130 may be fastened to a side of the square first director 110, the side of the square first director 110 is a straight edge, and the first stub 130 extends along the outer edge contour of the first director 110. Therefore, the first stub 130 may be of a linear stub geometry. In this way, the induced current generated by the high-frequency antenna on the first stub 130 and the induced current generated by the high-frequency antenna on the first director 110 have similar paths and opposite directions, and can cancel each other with each other, to implement wave transmission of the first director 110.

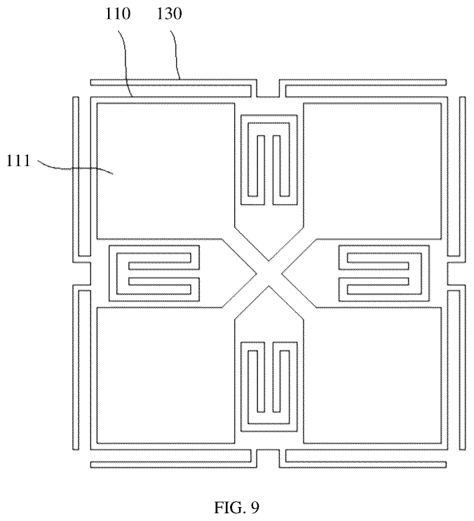

FIG. 9 is a diagram of a structure of the director structure according to another possible embodiment of this application. As shown in FIG. 9, the first director 110 may be square. The through hole 111 may be a square hole. In this case, the first director 110 is specifically a square ring. Different from the embodiment shown in FIG. 8, the first direction and the second direction may be respectively directions of side lengths of the through hole 111, and the first direction is perpendicular to the second direction. In a specific implementation, similarly, the first stub 130 may be fastened to a side of the square first director 110, the side of the square first director 110 is a straight edge, and the first stub 130 extends along the outer edge contour of the first director 110. Therefore, the first stub 130 may be of a linear stub geometry. In this way, the induced current generated by the high-frequency antenna on the first stub 130 and the induced current generated by the high-frequency antenna on the first director 110 have similar paths and opposite directions, and can cancel each other with each other, to implement wave transmission of the first director 110.

Several implementations of the first director 110 and the first stub 130 are described in the foregoing descriptions. In addition to the implementations described in the foregoing descriptions, the first director 110 and the first stub 130 may further have other implementations. The following lists several implementations for description.

In an implementation, the first director 110 may be circular, and the through hole 111 may be a square hole. In this case, the first director 110 is specifically in a ring shape with a circular outer contour and a square inner contour, the first direction and the second direction may be directions of diagonals of the through hole 111, and the first direction is perpendicular to the second direction. In a specific implementation, an overall outer edge contour of the first director 110 is circular, a partial outer edge contour of the first director 110 is arc-shaped, and the first stub 130 extends along the outer edge contour of the first director 110. Therefore, the first stub 130 may be of an arc-shaped structure.

In another implementation, the first director 110 may be circular, and the through hole 111 may be a square hole. In this case, the first director 110 is specifically in a ring shape with a circular outer contour and a square inner contour. Different from the foregoing implementation, the first direction and the second direction may be respectively directions of side lengths of the through hole 111, and the first direction is perpendicular to the second direction. In a specific implementation, an overall outer edge contour of the first director 110 is circular, a partial outer edge contour of the first director 110 is arc-shaped, and the first stub 130 extends along the outer edge contour of the first director 110. Therefore, the first stub 130 may be of an arc-shaped structure.

In another implementation, the first director 110 may be square, and the through hole 111 may be a circular hole. In this case, the first director 110 is specifically in a ring shape with a square outer contour and a circular inner contour, and the first direction and the second direction may be respectively radial directions of the through hole 111. That is, the first direction may be the radial direction of the through hole 111, the second direction may also be the radial direction of the through hole 111, and the first direction is perpendicular to the second direction. In a specific implementation, the first stub 130 may be fastened to a side of the square first director 110, the side of the square first director 110 is a straight edge, and the first stub 130 extends along the outer edge contour of the first director 110. Therefore, the first stub 130 may be of a linear stub geometry.

It may be understood that the foregoing examples of several integral possible implementations for the first director 110 and the first stub 130 may be selected based on a specific requirement during actual application. Certainly, other feasible implementations may be used during actual application, and may be specifically set based on an actual situation.

Numerals used in embodiments of this application are merely used for differentiation for ease of description, but do not limit the scope of embodiments of this application. Sequence numbers of the foregoing processes do not mean a sequence of execution. The sequence of execution of the processes should be determined based on functions and internal logic of the processes.

The foregoing descriptions are merely specific implementations of this application, but are not intended to limit the protection scope of this application. Any variation or replacement readily figured out by a person skilled in the art within the technical scope disclosed in this application shall fall within the protection scope of this application.

1.-20. (canceled)

21. A director structure, configured to be disposed above an antenna structure, and the director structure comprising:
a first director; and
at least one second director, wherein a through hole is in the first director, the at least one second director is disposed inside the through hole, and a first end of the at least one second director is fastened to the first director;
wherein at least one first stub is disposed on an outer edge of the first director, the at least one first stub extends along an outer edge contour of the first director, and the at least one first stub is fastened to the first director; and
wherein an opening is in the first end of the at least one second director, the opening extends in an extension direction of the at least one second director, a second stub is disposed in the opening, and the second stub extends in the extension direction of the at least one second director.

22. The director structure according to claim 21, wherein the at least one second director comprises four second directors, wherein the four second directors are arranged axially around the through hole, two of the second directors are arranged in a first direction, the other two second directors are arranged in a second direction, and the first direction is perpendicular to the second direction.

23. The director structure according to claim 21, wherein the second stub comprises a first segment, a second segment, and a third segment, the first segment extends in the extension direction of the at least one second director, the second segment and the first segment are disposed in parallel, and the first segment is fastened to the second segment via the third segment; and
wherein the third segment is fastened to the at least one second director.

24. The director structure according to claim 23, wherein one end of the third segment is fastened to one end of the first segment, the other end of the third segment is fastened to one end of the second segment, and the first segment and the second segment are located on a same side of the third segment.

25. The director structure according to claim 21, wherein the first director is circular.

26. The director structure according to claim 21, wherein the first director is square.

27. The director structure according to claim 21, wherein the first stub is fastened to the first director via a first connecting member.

28. The director structure according to claim 27, wherein one end of the first connecting member is fastened to one end of the first stub, and the other end of the first connecting member is fastened to the first director.

29. The director structure according to claim 23, wherein the third segment is fastened to the at least one second director via a second connecting member.

30. The director structure according to claim 29, wherein the second connecting member, the first segment, and the second segment are located on a same side of the third segment.

31. A base station antenna, comprising:
an antenna structure; and
a director structure, wherein the director structure is disposed above the antenna structure, and the director structure comprises a first director and at least one second director, wherein a through hole is in the first director, the at least one second director is disposed inside the through hole, and a first end of the at least one second director is fastened to the first director;
wherein at least one first stub is disposed on an outer edge of the first director, the at least one first stub extends along an outer edge contour of the first director, and the at least one first stub is fastened to the first director; and
wherein the first end of the at least one second director has an opening, the opening extends in an extension direction of the at least one second director, a second stub is disposed in the opening, and the second stub extends in the extension direction of the at least one second director.

32. The base station antenna according to claim 31, wherein the at least one second director comprises four second directors, wherein the four second directors are arranged axially around the through hole, two of the second directors are arranged in a first direction, the other two second directors are arranged in a second direction, and the first direction is perpendicular to the second direction.

33. The base station antenna according to claim 31, wherein the second stub comprises a first segment, a second segment, and a third segment, the first segment extends in the extension direction of the second director, the second segment and the first segment are disposed in parallel, and the first segment is fastened to the second segment via the third segment; and
wherein the third segment is fastened to the at least one second director.

34. The base station antenna according to claim 33, wherein one end of the third segment is fastened to one end of the first segment, the other end of the third segment is fastened to one end of the second segment, and the first segment and the second segment are located on a same side of the third segment.

35. The base station antenna according to claim 31, wherein the first director is circular.

36. The base station antenna according to claim 31, wherein the first director is square.

37. The base station antenna according to claim 31, wherein the first stub is fastened to the first director via a first connecting member.

38. The base station antenna according to claim 37, wherein one end of the first connecting member is fastened to one end of the first stub, and the other end of the first connecting member is fastened to the first director.

39. The base station antenna according to claim 33, wherein the third segment is fastened to the at least one second director via a second connecting member.

40. A base station, comprising:
a base station antenna comprising an antenna structure and a director structure, wherein the director structure is disposed above the antenna structure, and the director structure comprises a first director and at least one second director, wherein a through hole is in the first director, the at least one second director is disposed inside the through hole, and a first end of the at least one second director is fastened to the first director;
wherein at least one first stub is disposed on an outer edge of the first director, the at least one first stub extends along an outer edge contour of the first director, and the at least one first stub is fastened to the first director; and
wherein an opening is in the first end of the second director, the opening extends in an extension direction of the second director, a second stub is disposed in the opening, and the second stub extends in the extension direction of the second director.
